(19) United States
(12) Patent Application Publication
(10) Pub. No.: US 2004/0185786 A1
(43) Pub. Date: Sep. 23, 2004

(54) Quality of service state predictor for and advanced mobile devices

(76) Inventors: Ramin Mirbaha, Dachau (DE); Vahid Mirbaha, Eching (DE)

Correspondence Address: FISH & RICHARDSON, PC, 12390 EL CAMINO REAL, SAN DIEGO, CA, 92130-2081, US

(21) Appl. No.: 10/475,895

(22) PCT Filed: Mar. 19, 2002
(86) PCT No.: PCT/EP02/03018

(30) Foreign Application Priority Data
Apr. 25, 2001 (WO) PCT/EP01/04655

(51) Int. Cl. H04B 17/00

(52) U.S. Cl. 455/67.11

(57) ABSTRACT

A mobile device and method for predictive computing of variable mobile link parameters per session and state in a future time interval within Radio Access Networks (RAN). The system narrows its prediction errors as time progresses. An ideal control value is also estimated, so that mobile QoS applications can determine their intervention point while coexisting with link layer resource management mechanisms. The system is provided with certain measurement elements from the RAN. With the information contained in these elements, the system estimates the Received Signal Strength (RSSI), Received Wideband Power (RSCP), Signal Interference Ratio (SIR), Bit Error Rate (BER), the transmission delay per frame (delay), the variation between delay measurements throughout a certain number of measurement time frames and the mean bit throughput rate (Chip Rate) for a future time interval. The system also calculates the optimal power control (gain) for a defined value target of a given link parameter. The estimates are passed on to other Systems for further processing.

### BACKGROUND OF THE INVENTION

1. Technical Field

The present invention relates in general to the prediction of changes in a mobile communications environment. In particular to a method of predicting mobile link characteristics while at least one party is in motion. Still more particularly, the present invention relates to a method of predicting Link Quality Parameters in 2.5 and 3G mobile access networks, considering lower layer corrective mechanisms such as power control, to aid QoS (Quality of Service) systems and Applications in their quality management process.

2. Description of the Related Art

The standardization of wireless systems beyond the current second-generation is rapidly progressing in all major economic regions of the world. These systems are known under names such as IMT-2000 (ITU), UMTS (ETSI 3GPP), EDGE and ANSI 3GPP2. While current systems such as GSM, PDC, ISI36 and IS-95 have been used for circuit oriented voice telephony, the newer generation of mobile access networks also known as 2.5 and 3G will off more bandwidth and services. The main application for these services will be wireless packet transfer. The transport of IP (Internet Protocol) packets over the air interface not only extends the reach of the internet to the mobile user in a known and trusted fashion, it also opens the opportunity to migrate all of the communication to a packet switched environment. By gradually eliminating the need to establish separate logical circuits between the end device and the next mobile network node, the scarce radio resources can be put to work in a more efficient manner. This will lead to lower Network Operating Expenses (NETEX) and in turn to more attractive subscription or transaction models.

Using IP as the transport mechanism for mobile radio networks also has its challenges. Typical services with real-time requirements are packetized voice and video, as well as delay sensitive applications such as traffic signaling, remote sensoring and interactive web applications. The challenge here is to provide acceptable quality while maintaining spectrum efficiency. “Acceptable quality” is what the human user preceives to be “good”. Voice applications such as voice telephony have been in use for a long period of time and certain delay, jitter, and loss boundaries are now known to be “good”. Any conversation with a one way delay of more than 150 ms or 12-15% packet loss or more than 10 ms jitter is perceived to be degraded or unusable. In particular, the areas of concern are:

Spectrum efficiency

Low latency

Data integrity

Sufficient bit rate

While spectrum efficiency is being addressed by robust compression schemes both for the payload and the packet header, the current invention supports and enhances existing schemes to achieve acceptable values for the latter 3 areas.

Some factors that have an influence on the link quality are:

Voice activity: drives the codec mode and bit rate. Some codecs such as the AMR codec include voice activity detection (VAD) and generation of comfort noise (CN) parameters during silence periods. Hence, the codecs can reduce the number of transmitted bits and packets during silence periods to a minimum. The operation to send CN parameters at regular intervals during silence periods is usually called discontinuous transmission (DTX) or source controlled rate (SCR) operation.

Loading: this is the effect of neighbor cells in different load states. A base station serving more than 60 subscribers in a Rural Urban area will transmit at high power levels, influencing the link quality in adjacent cells.

Sectorization: In order to serve more subscribers, cells may be sectorized. This involves more hand offs called “softer” hand off.

Multipath fading: occurs as signals bounce of objects, arriving both directly and indirectly. This effect influences the delay boundries as signals arrive at different phases. The effect is a volatile BER due to varying SIR.

Power control mode: depending on the mode employed (open or closed loop) interference may occur with neighboring UEs.

Cell and RAT hand offs: also called soft and hard hand offs influence the transport context and indirectly the subjective quality perception. In cases where the Radio Access Technology (RAT) is changed (e.g. from an UMTS access network to a GSM network), hard hand offs may cause large transmission delays.

Terrain: whether the surrounding is an open plain or a mountainous region has an affect on the various propagation models. While generally radio propagation delays such as the multipath rayleigh fading have been regarded as quality degrading, this is to a certain extent different for CDMA based networks. In these cases, the effect of multipath fading can both degrade or upgrade the Signal to Interference (SIR) value. Depending on the dimension und duration of such effects, the user of the current invention will benefit from accurate SIR predictions.

Radio Coverage: Obviously, the degree of cell coverage, especially in sparsely populated regions, is one of the main contributors to link quality.

Velocity: most of the factors described above have a direct relationship with the speed with which the UE travels. Most notably, the hand off procedures and power control mechanisms are directly influenced by the speed and direction of the UE.

Existing QoS Schemes address changes in the link quality through various methods. Most known systems attempt to adapt to the changing quality environment induced through mobility.

U.S. Pat. No. 6,101,383 describes a method for predicting the signal strength of a broadcast channel in a GSM network. The mobile station points out a broadcast channel, which based on the measured signal strength is predicted soon to be one of the strongest broadcast channel carriers, taking into account the signal strength average values over one of the plurality of measuring periods. The system does not estimate control values, which may improve the transmission of information under a predefined quality of service.

U.S. Pat. No. 5,845,208 discloses a network system that analysis the receiving power in a cellular radio system. The mobile station measures the strength of the signal received from a base station and reports the result to that base station. The base station estimates the future values and adjusts the sending power.

U.S. Pat. No. 5,878,342 discloses a method and a system for estimating supervisory altered ton strength during data transfer and for a short time thereafter. The mobile station transmits information about the strength of the message sent wherein the base station estimates the future values.

U.S. Pat. No. 5,506,869 shows a method and apparatus for estimating carrier to interference ratios of signals transmitted between cellular radio base stations and mobile units, a SAT signal is transmitted from a base station to a mobile unit served by that base station. The mobile unit receives a key signal and retransmits the received SAT signal to the base station. A first order auto-regressive parameter is calculated for the received SAT signal at the base station. The base station executes further calculations. The mobile unit is not involved in any calculations.

U.S. Pat. No. 5,591,837 describes a method and a system for the adaptive allocation of channels within a radio communication system. The allocation method takes advantage of measurements made by the mobile radio telephone and allocates channels based on the carrier to interference ratio. The system does not predict any future values. It just reacts on changes of the carrier to interference ratio.

EP 1059792 discloses a QoS agent for an Internet-Protocol, that collects information in a central store and determines the QoS for special applications.

WO 00/04739 describes a system that predicts a channel allocation depending on the interference level of the cellular radio network. The estimation is done by the base station which decides if an incoming call has an impact on the interference level or the quality.

WO 00/56103 discloses a network system including base stations and subscriber units which comprises means for comparing information about the transmit power level sent by the base stations. Depending on the power levels sent by the base stations the mobile subscriber chooses the best base station. The mobile subscriber does not predict any future power level.

WO 96/10301 describes a method that selects channels in a radio network by predicting on the basis of measured momentary fading of the transmitted signal the best channel. The prediction of unsuitable channels is made from the fact that the unit has performed measurements which are considerably shorter than the mentioned average. The system does not change any control values.

EP 455 614 A discloses a mobile radio communication system, where the mobile devices measures values which will be sent to a base station that predicts future values.

U.S. Pat. No. 5,794,155 discloses a dynamic communication system, where a subscriber employs predicted communications parameters in resuming communications without requiring complex reallocation of an additional communication link.

WO 00/33479 describes a wireless mobile station, that exchanges power control information over a communication channel with the base station. The power control circuitry uses power control commands in response to a determined mobility of the mobile station.

The current invention offers an enhancement to these systems by providing future measurements, target measurements and the related control values that have not been part of the known art evaluated by the mobile user equipment itself.

### DETAILED DESCRIPTION OF INVENTION

The present invention addresses the need to know quality variations in the radio access network in advance. The quality variation arises through the motion of the mobile user, the engagement of resources, as well as sporadic disturbing factors relevant the radio access network. Quality state changes generally effect packetized real-time applications adversely. The nature of the fast changing link state within a wireless mobile environment requires anticipatory and pre-emptive measure to contravene the effects. Thus, providing link state information and control input values in advance is a valuable support for any QoS management system. The provision of such support is made possible by the present invention.

One part of the invention is a mobile user device for a communication network, comprising means running a process for predicting and improving the transport quality of packetized application data in a radio access environment. The device includes one or more processors having access to a RAM and to interfaces. These interfaces allow the access to QoS measurements and control values. The process comprises the following steps:

A first step includes the recording of quality measurements and control values periodically e.g. a received signal code power (RSCP), a position, a direction, an altitude, a velocity of the device, a received signal strength indicator (RSSI), a block size, a codec, a header compression, traffic volume, transmission delay, block error rate, bit error rate and/or signal to interference ratio (SIR).

In a next step future quality measurements are estimated periodically. These measurements are in particular the traffic volume, transmission delay, block error rate, bit error rate, or the signal to interference ratio (SIR). In a preferred embodiment the calculation is based on a multidimensional stochastic algorithm, that uses the information collected in the past. More precisely the algorithm use covariance matrices. In an alternative embodiment the mobile device uses a neuron system. The different types of neuron systems are state-of-the-art.

In the next step the estimated future quality measurements are compared with the desired values. These desired values are minimum values that allow a specific type of communication e.g. voice, data, video. If the estimated future quality measurements do not match a predefined quality of service the control values will be adapted in the near future.

In an alternative embodiment the mobile device sends the estimated future quality measurements and/or the calculated future control values to a device in the network that is responsible for the adaptation of the control values. This device may be a base station or a radio network controller (RNC). The network device may determine the control values on the basis of the estimation or may use the control values without any further prediction and calculation. In the first example the base station or the radio network controller must determine the preferred control values that have to be adapted to guaranteed a predefined quality. By sending the predictions or the calculated future control values to the base station or to the radio network controller the mobile device loses the control over the future control values. One advantage of this alternative is that the central devices in the network are able to manage the resources for all network users, so that a fair distribution of resources is guaranteed.

Note that the invention comprises permutations of these steps also.

To improve the quality of the used algorithm the process compares in a further step the estimated quality measurements with real quality measurements. If the error is above a predefined level the algorithm will be altered. In the preferred embodiment the covariance matrices will be recalculated, using recently collected information. In the alternative embodiment the neuron network is modified by methods known by the state of the art. To compare the measurements the algorithm uses a predefined metric.

Another implementation uses genetic algorithms or simulated annealing, see for details [21] [22].

To gain a big market share it is necessary to offer software that is independent from the type and brand of the mobile device. The software has the ability to run on different platforms. This can be done by compiling the software for different target systems. Another possibility is an interpreter running a system independent code like Java or c##. The software should be optimized to reduce the amount of memory used on the PDA or mobile phone. Furthermore the software should use libraries being optimized to calculate probabilities. In a preferred embodiment a ieee-lib is used.

This software phone implements the above mentioned process in particular on a mobile PDA or a mobile cellular phone.

Another part of the invention is a computer readable medium storing a load-able data structure implementing the above-mentioned process.

A further part of the invention is a network for a mobile user device including network controlling components in particular a base station and/or a radio network controller allowing the execution of the described process.

In some networks, the access to quality measurements and control values may be restricted. These networks must open their gates to improve the quality of service, which is primarily driven by the mobile end-user equipment. The mobile device stores the information needed to calculate the future behavior of the user carrying the device and the parameters needed to adapt the transmission control. In some networks, a special protocol needs to be implemented to enable the communication between the mobile devices and the network components, if the mobile device itself cannot determine the desired information. This protocol allows the mobile user device to access and record quality measurements and control values periodically, in particular the received signal code power (RSCP), the position of the device, the direction, the altitude and velocity of the device or the received signal strength indicator (RSSI) and the block size.

The mobile user device estimates the future quality measurements periodically as described above. The described methods are also mentioned-above. If the future quality measurements do not match a predefined quality of service, the network component allows the mobile user device to modify the control values. The algorithm for the control value estimation is disclosed below. The control values will be adapted early enough to keep the quality of service on a high level. The adaptation may be linear or in small steps.

In an alternative embodiment the estimated quality measurements are sent to the base station or the network controller calculating new control values. The calculated control values are then used to optimize the exchange of information. In an alternative embodiment, the mobile device sends the estimated control values to the base station or radio network controller, which amends the control values if the traffic in the network will allow it. The invention discloses different possibilities of distributing the payload between the network components and the mobile device. In one extreme, the mobile device will estimate the quality measurements, the control values and change the control values in time. In another extreme, the predicted quality measurements will be sent to the network components, which calculate and adapt the control values.

Note that all reasonable combinations of features disclosed in the claims are part of the invention.

As already described above, the main goal for the State Predictor is to help the system to achieve a desired level of QoS (or to retain the current satisfactory level), i.e., the link state quality between UE and UTRAN. Depending on which method is used, the State predictor can work in two modes: Prediction of future quality measurements (CVA) or Estimation of future optimal controls (MPC).

In a preferred embodiment the invention is divided into two components: the state predictor and the service manager. The Working mode between the two components is negotiated during the initialization phase between the State Predictor (SP) and Service Manager (SM), and depends on whether the SM has an active control over the RSCP (Base-band), ROHC and/or AMR signaling and compression modes. If it does, the SM can negotiate the SP to work in the MPC mode and then it is responsible to tailor the BB and/or codecs to follow the prescribed controls. Otherwise, the default CVA mode must be applied, and SM simply has to provide to the BB and codecs the predicted (estimated) values of future quality measurements, to leave them alone to change their internal states to overcome the predicted future environmental changes.

Broadly speaking, the estimations are achieved by observation and prediction. The system does not require specific knowledge of a relationship model to initiate the process.

The following steps describe an example of the method of observing and computing ideal values for QoS Levels:

1. Observe and record the following measurements. It is assumed that the following measurements are provided to the system:

a. Received Signal Code Power (RSCP, [4, 5])

b. Signal to Interference Ratio (SIR, [4, 5])

c. Received Signal Strength Indicator (RSSI or wideband received power, [4, 5])

d. Traffic Volume Measurement [1]

e. one way transmission delay ([1, 6,])

f. Block size [2]

g. Block Error Rate [1]

h. UE position, direction (bearing), altitude and velocity [7, 8]

2. Construct covariance matrices for the sum of all changing vectors

3. Use the known interdependencies to estimate future values for certain vectors, while minimizing the prediction error

4. Given optimal target vector trajectories (QoS profile), determine future control(s) values required, in order to achieve the desired trajectory. As an example: if the agreed Service Level for the current QoS Profile includes a Bit Error Rate (BER) of 10-4, how much power gain is needed to equalize the effect of the Doppler shift, path and multipath fading, considering the relationship between motion, direction, Network coverage etc. An external system provided with this information can make an educated decision on the type of response it will make before limitations become obvious. Such responses could be in the change of coding rate or compression ratio. Other applications can us this information to change the protection method (Unequal Error Protection) or fine tune this to meet the predicted change.

In the preferred embodiment the underlying mathematical methods CVA and MPC and algorithms employ (QR Factorization and SVD Decomposition). Another issue is computational complexity and or the implementation.

For the purpose of mathematical presentation of CVA and MPC methods the standard notation will be used: “input” and “output” (without quotations), where “input” relates to the control measurements, and “output” relates to the quality measurements. Further mathematical details for all methods and algorithms as listed can be found in the reference section.

Canonical Variate Analysis (CVA):

The given past vector pₜ consists of past outputs yₜ and past control inputs uₜ

pₜ^{T}=(yₜ₋₁, yₜ₋₂, . . . , uₜ₋₁, uₜ₋₂, . . . )

and the prediction of the future output is wanted

fₜ^{T}=(yₜ, yₜ₊₁, . . . )

Input and output processes are assumed jointly stationary and the corresponding covariance matrices are denoted by ΣₚₚΣ_{pf}, and Σ_{ff}, respectively.

The estimated future output should be modeled as a linear form of the known past

\hat{f}ₜ=Kpt

and the error between the actual future and predicted future

$$E \{ {‖ {f}_{t} - {\hat{f}}_{t} ‖}_{Λ}^{2} \} \to min$$

should be minimized. The solution is given by

K=Σ_{fp}JₖJₖ^{T}

where k is determined by Akaike Information Criterion (AIC), Jₖ represents the first k columns of J, and matrix J is calculated from the Generalized Singular Value Decomposition (GSVD), namely to satisfy

J^{T}ΣₚₚJ=Iₘ

L^{T}Σ_{ff}L=Iₙ

J^{T}Σ_{pf}L=D

and D is a diagonal rectangular matrix consisting of generalized singular values.

Computational complexity is of cubical order O(N³), where N denotes the greatest input dimension.

Model Predictive Control (MPC):

Definitions:

Observed past inputs Uₜ^{pT}=(uₜ₋₁^{pT}, uₜ₋₂^{pT}, . . . )

Observed past outputs Yₜ^{pT}=(yₜ₋₁^{pT}, yₜ₋₂^{pT})

Observed past of the desired trajectory Sₜ^{pT}=(sₜ₋₁^{pT}, sₜ₋₂^{pT}, . . . )

Future control inputs Uₜ^{fT}=(uₜ^{fT}, uₜ₊₁^{fT}, . . . ) that can be manipulated

Future outputs Yₜ^{fT}=(yₜ^{fT}, yₜ₊₁^{fT}, . . . ) to be controlled by the future controls Uₜ^{fT}

Desired future trajectory Sₜ^{fT}=(sₜ^{fT}, sₜ₊₁^{fT}, . . . ) in terms of desired future outputs

The observed past pₜ covers all together the past inputs, outputs and the past trajectory. pₜ is denoted by pₜ^{T}=(uₜ^{pT}, Yₜ^{pT}, Sₜ^{pT}). Inputs and outputs are assumed jointly stationary stochastic processes, and the desired future trajectory is assumed proposed.

One of the goals is to navigate the future output by manipulating the future control, and we want to minimize what we denote as a performance criterion

$$Δ = E \{ {‖ ( {S}_{t}^{f} - {Y}_{t}^{f} ) - {Y}_{t}^{f} ( {U}_{t}^{f} ) ‖}_{Q}^{2} + {‖ {U}_{t}^{f} ‖}_{R}^{2} \} \to min$$

where Yₜ^{f}+Yₜ^{f}(Uₜ^{f}) denotes the total future output due to our manipulated future control.

Again, we want to model the future control as a linear form of the known past

Uₜ^{f}=Kpₜ

The optimal control gain is given by

K=C⁺ΣₜₚJₖ^{T}[JₖΣₚₚJₖ^{T}]⁻¹Jₖpₜ

and the corresponding (minimal) corresponding criterion can be expressed as

Δ=trΣ_{zz}−trCC⁺Σ_{zm}Σₘₘ⁻¹Σ_{mz}

where C and zₜ are formally defined by

$$\begin{matrix}Δ = E \{ {‖ ( {S}_{t}^{f} - {Y}_{t}^{f} ) - {Y}_{t}^{f} ( {U}_{t}^{f} ) ‖}_{Q}^{2} + {‖ {U}_{t}^{f} ‖}_{R}^{2} \} \\ = E {‖ ( \begin{matrix}{Q}^{1 / 2} B \\ {R}^{1 / 2}\end{matrix} ) {Km}_{t} - ( \begin{matrix}{Q}^{1 / 2} ( {S}_{t}^{f} - {Y}_{t}^{f} ) \\ 0\end{matrix} ) ‖}^{2} \\ = E {‖ {CKm}_{t} - {z}_{t} ‖}^{2}\end{matrix}$$

and Σₘₘ, Σ_{mz} and Σ_{zz} are the corresponding covariance matrices. As previously, k is determined by AIC.

This method is little more complex than CVA, but still of cubical order O(N³), where N denotes again the greatest input dimension.

QR Factorization:

Let matrix A be of order m×n. Then there is unitary (orthogonal) matrix Q and upper triangular matrix R, such that

A=QR

where R=Pₙ₋₁ . . . P₁A and Q^{T}=Pₙ₋₁, . . . P₁, and Pᵣ are a Hausholder matrices (r=1, . . . , n−1). The method has computational complexity of cubical order O (N³), where N is the greater dimension of m and n.

Singular Value Decomposition (SVD):

Let matrix A be of order m×n. Then there are unitary (orthogonal) matrices U and V, of order m and n, respectively, such that

V^{T}AU=D

Here, D is diagonal rectangular matrix consisting of singular values for the matrix A.

The method has computational complexity of cubical order O (N³), where N is the greater dimension of m and n.

These predictions include the behavioral influence of control inputs such as dynamic power control. However, in certain circumstances, the corrective influence of a control mechanism (i.e. fading compensation) may either have natural or given limits. This is the case for equalizing the signal fade through increase of transmit power until limits set either by the operator or legal bodies are reached. In other instances the gain in transmit power may interfere with other subscribers or more commonly induce self interference which will in turn increase the Bit Error Rate. Although in most cases cell hand off procedures relax this situation, these procedures induce quality degradations of their own. Other control mechanisms such as Forward Error Correction (FEC) have limitations specific to the employed method. In this case it is the additional bandwidth required to transport the FEC packets.

Considering these limitations of control mechanisms, the question that arises is: at which point will a corrective measure either produce incremental results below minimum expectancy or generate side effects such as interference or delay, which are undesirable.

### AN EXAMPLE

Assuming that the described method uses the following information:

RSSI, SIR, BER, Rx-Tx delay

After an observation period covering ideally at least 80 samples, and applying these values to the described methods, a RSSIₜ₊₁ and transmit power gain (power control) PCₜ₊₁ can be determined. These and other predictions are provided to external applications using an output frame or structure. In case of an application using the AMR WB codec, the PCₜ₊₁ value would be used to determine the point in time for intervention. At such time, the external QoS Management application may decide to replace the current RSSI value contained within the current AMR frame with the predicted RSSIₜ₊₁ supplied by the current invention. The codec bit rate would be adapted to a link state just about to occur. Of course, this would only apply to the receive side of the codec signaling a mode change to the encoding peer. However, applied correctly, the pre-emptive mode change would lower the amount of residual bit error per block of information relevant to the codec.

### BRIEF DESCRIPTION OF THE DRAWINGS

FIG. 1, is a table of QoS quality parameters widely used in Radio Access Networks.

FIG. 2, is a table showing control inputs (power control) and the respective tolerance ranges

FIG. 3, generic view of codec mode changes relative to channel power.

FIG. 4 is a diagram illustrating the Information Element (IE) containing the output of the state predictor

FIG. 5 is a block diagram showing the steps involved in making link state predictions

FIG. 6 is a block diagram of QoS Management System advantageously using the current invention.

FIG. 7, is a block diagram depicting the layer positioning of the current invention relative to the 3GPP model.

FIG. 8, is a theoretical output graph employing the algorithms described in this invention.

### DETAILED DESCRIPTION OF DRAWINGS

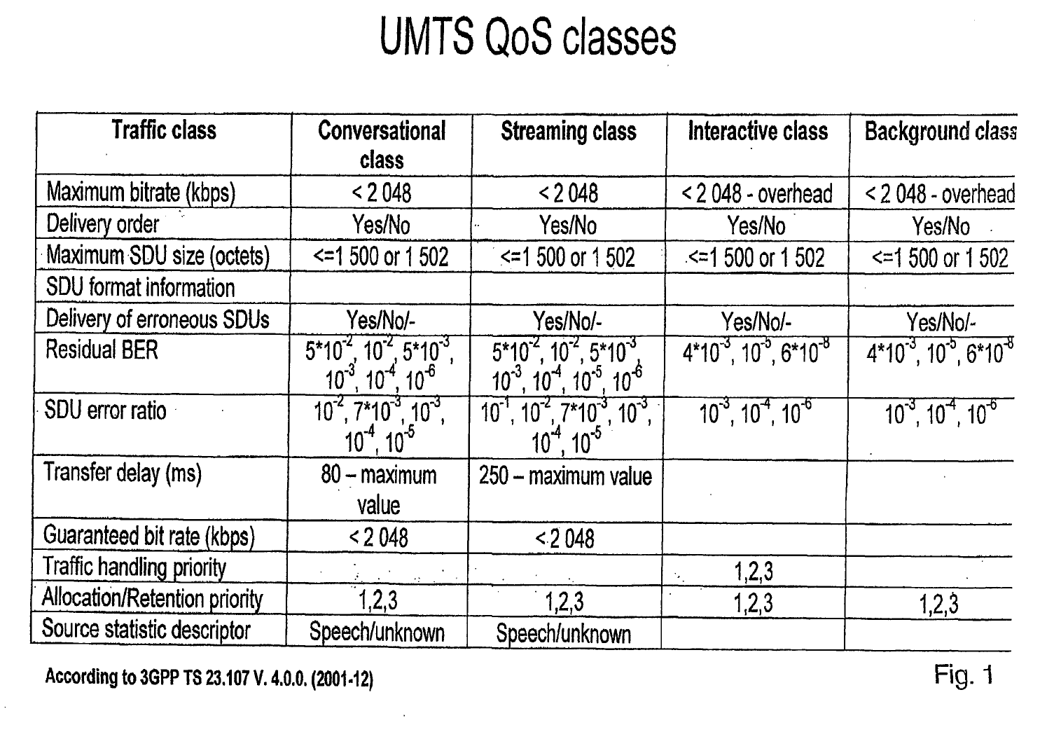

Referring to FIG. 1, listing the QoS classes defined by the 3GPP working groups, for which the Universal Terrestrial Radio Access Network (UTRAN) has been designed. Each class shows a large range of acceptable values. Of particular interest for real-time applications is the residual BER, which is defined as the error rate that is not detected or corrected by lower layers and actually effects the application. With a residual BER of 10⁻⁴, a frame length of 1500 bytes and a packet length of 256 bytes, the application could be confronted with as much as 15-20% packet loss. The current invention is designed to assist QoS management systems in dealing with these type of situations as early as possible or useful.

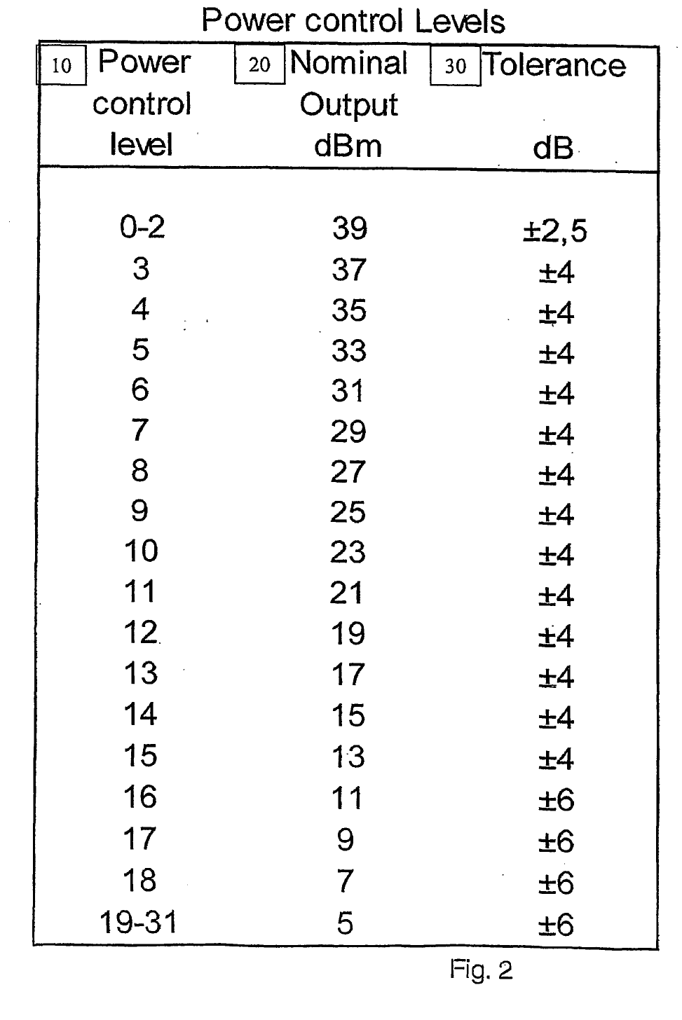

Referring to FIG. 2, a reference table consisting of the power control level [symbol] , which denotes the control state the power management unit can take. The nominal output power [symbol] is the power the user equipment (UE) must transmit when commanded by the respective power control level. Although the power control may exceed this in some cases, the maximum specified and permitted power output is generally not higher than 33 dBm.

The tolerance range [symbol] shows when a power control level is changed and so a new control command issued. The reader can observe the tolerance range is lower at higher output numbers. This is related to the rise of interference, which is directly related to the transmitted power. Hence, in a scenario in which the UE travels away from the serving base station, a natural limit is set to the point in time when a drifting cell must have been selected for hand off. Similarly, in closed environments such as cars and trains, power levels at 6 and below may cause interference with other UEs. In such cases a hand off may not occur, as the hand off thresholds may not have been reached. However, the increased Bit Error Rate would either require a pre-mature hand off or a lower transfer rate. This is a common scenario when traveling with public transportation means in rural areas.

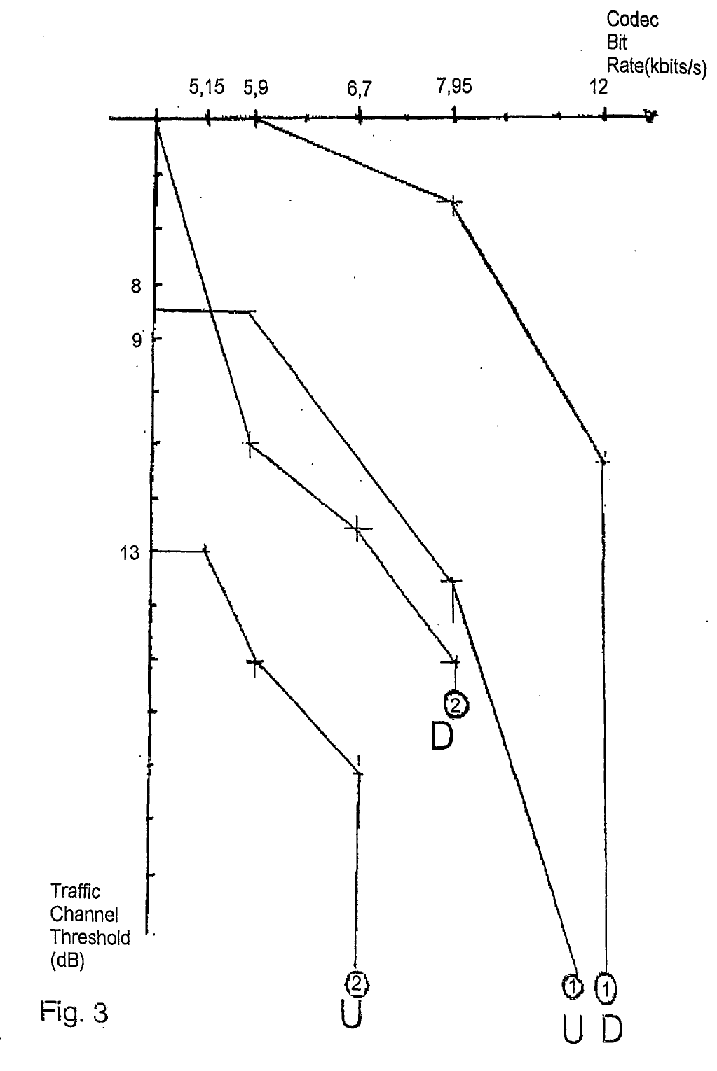

Referring to FIG. 3, a diagram showing thresholds for codec mode changes. Two AMR codecs with different capabilities are used. 1D and 1U show thresholds levels for a 3 mode codec (5.9; 7.95 and 12.2 Kbps) where D denotes the downlink connection a U the uplink connection. Similarly, the curves 2D and 2U show applicable thresholds for mode changes relative to a 4 mode AMR codec. The current invention makes use of the described model, in order to support and invoke a mode change immediately prior to the link state change.

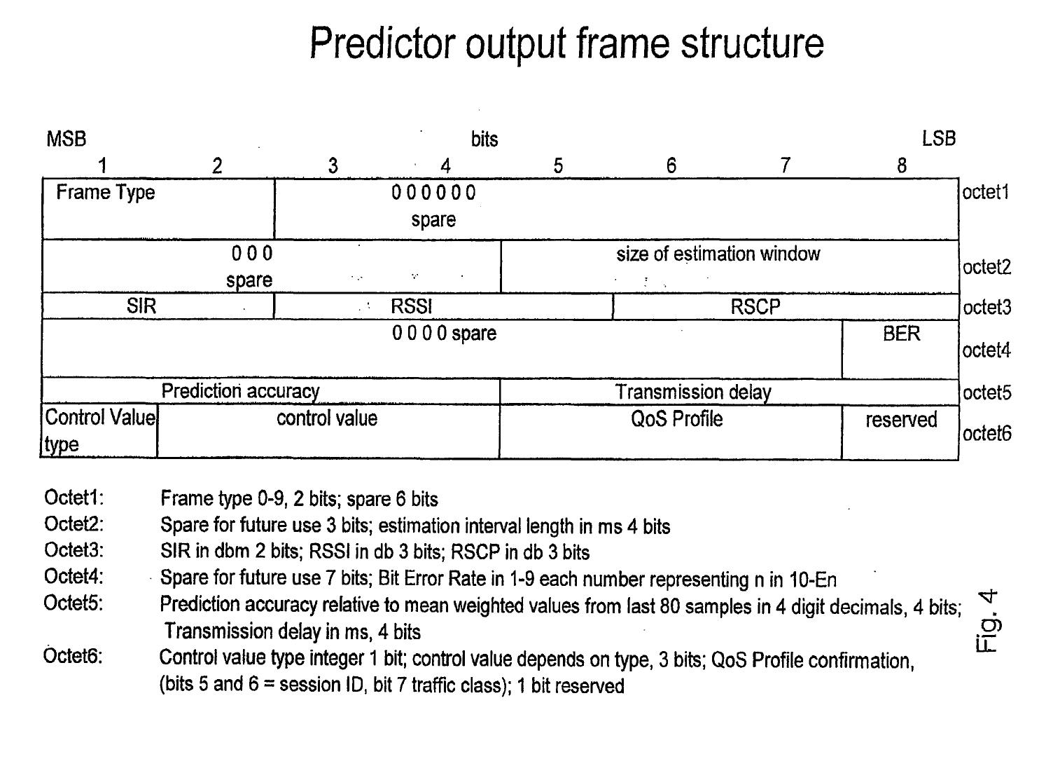

Referring to FIG. 4, an overview of the frame structure used to present the results of the current invention to external applications. The frame is denoted Information Element (IE) for compliance reasons to 3GPP specifications. It is organized octetwise.

Type Comment

Octet1

Bits 1-2: This contains the frame type. Frame types are defined as follows:

1 3GPP release 99 conforms with 25.215 sub-clause 5.1 and 25.225 sub-clause 5.1

2-0 reserved

Bits 3-8: reserved

Octet2

Bits 1-4: reserved

Bits 5-8: size of estimation interval in ms. The window size depends on the size of the prediction error from the past n predictions while applying a progressive weighting mechanism in order to weigh heavier on the most recent estimates. Future extensions of the current invention may also change the windows size based on factors such as terrain, speed or application specific requirements.

Octet3

Bits 1-2: Signal to noise ratio (SIR) as defined in 3GPP TS 25.331 v. 3.5.0 expressed in dBm. This value contains the estimation of SIR within the estimation window which is used by various applications such as the AMR codec as an indication of possible BER values.

Bits 3-4: Received Signal Strength Indicator (RSSI) as defined in 3GPP TS 25.331 v. 3.5.0.

Bits 5-8: Received Signal Chip Power (RSCP) as defined in 3GPP TS 25.331 v. 3.5.0.

Octet4

Bits 1-7: reserved

Bit 8: Bit Error Rate (BER) 1-9, where each integer represents n in 10E-n

Octet5

Bits 1-4: Prediction Accuracy expressed in 3 digits and interpreted as percent, relative to the progressive weighted average of all estimates of t−1 compared to measurements of t−1

Bits 5-8: Transmission Delay as defined 3GPP TS 25.331 v. 3.5.0, expressed in ms.

Octet6

Bit 1: Control value type, integer, 1 bit. Definitions are:

1. Power control level

2. Class A protection length (UED/UEP) according to [16]

3. Codec Mode according to UE capability statement 3GPP 21.904 v. 3.3.0 and codec type

4. Multiple frame encapsulation according to [17]

5. Robust header Compression (ROHC) [10], mode

6. Robust header Compression (ROHC) [10], state

7-9. reserved

Bits 2-4: Control value quantity depending on supplied type:

Type: 1=power control level

2=MSB Coding point in absolute bits, left to right

3=Codec Mode depending on UE statement

4=number of multiple frames in RTP

5=ROHC mode type (001 through 009)

6=ROHC state type (001 through 009)

Bits 5-7: Profile number to be determined by the QoS Management System and current invention

Bit 8: 0-9 reserved

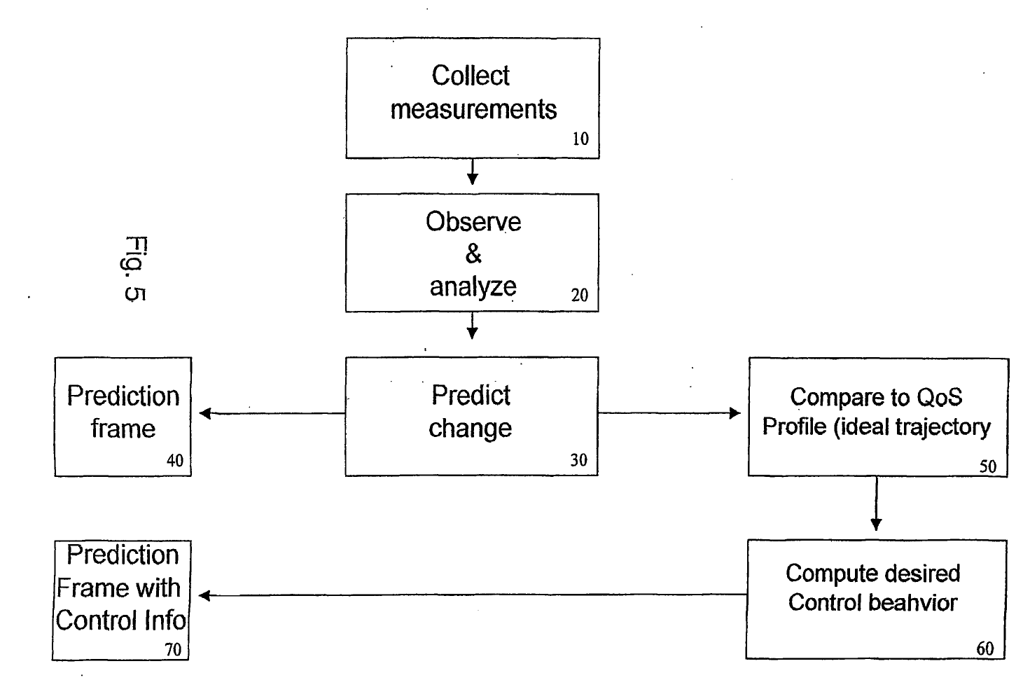

Referring to FIG. 5, a simple overview of the main processes of this invention. The measurement collection 10 is done via the C-SAP of the RRC UE control agent [1].

Once a minimum number of input values have been collected, their progression in time is observed 20. Not only the time based change per singular value (such as BER) is of interest but also variations between these values, that show a correlation. The invention does not require an initial model of the relationships between the measured vectors. With other words, it is not a prerequisite to provide a relevant propagation model to initiate the analysis. The reader will appreciate the “data in-model out” approach employed within the invention. Although the exemplary embodiment is based on a UMTS environment, it can be applied to any mobile system. This allows the addition of any new input type or control mechanism without the need for a reference model. Similarly, any desired quality value can be idealized, delivering the prediction capabilities to a large number of mobile environments.

In order to analyze the instantaneous covariations among the input vectors (which progress continuously in time) a specific statistical method called CVA is employed. More specifically, within the CVA mechanism, a generalized singular value decomposition which transforms a basis set of input variables and future output variables to correlated random variables is employed. The matrices are obtained via a singular value decomposition (SVD) of the cross-covariance matrix. The exact method is described in [15]. Provided sufficient number of observation samples, the operation provides an accurate expression of the momentary relationship and dependencies between all input variables.

With Other Words:

Given speed, direction, RF values such as RSSI, RSCP and SIR, given FER, transmit delay, bit throughput and sufficient samples, the “predict change” 20 module will a) predict the how these values will change and, more importantly, b) express the interdependencies for a given time interval.

It is possible to know the state of the link quality in the future. To a system without an explicit statement of the desired QOS parameters (QoS Profile) this information is presented as an Information Element (IE) containing the estimates [symbol] . The IE is described in detail in explanations to FIG. 4. In a mobile system without corrective control, pure estimates of state changes are sufficient to determine adequate equalization measures. For example, in a mobile system without any power control, the future estimates of BER and delay can be used to adjust compression rate and frame lengths in advance.

Given a certain QoS profile, it is of interest to determine the ideal control required to satisfy the profile. For this purpose the profile is interpreted as a desired trajectory of the input values 50. If the system does not foresee corrective methods, the invention reverts back to the simple IE 40. However, in most current and planned mobile systems there is at least the element of power control present. In this case, the question that is of interest is: Will the corrective measure, inherent to mobile system, satisfy the QoS or Service Level desired by the application? If not, at which point in time should an additional QoS Management System (if present) or other additional corrective measures be activated and to which extent?

The answer is influenced by the following factors:

1. The interdependencies of all time sensitive variables

2. The QoS Profile itself.

3. The effect of the corrective measure in question on the system and the prediction accuracy.

4. The complex effects of the plurality of corrective measures in the over all mobile system at that point in time.

Module 60 in FIG. 9 addresses the first 3 areas. A simple description is provided in a previous section of this document. For a detailed explanation, the reader skilled in the art is advised to refer to [15]. The output of this function assumes that further analysis of the computed ideal future control is carried out by upper layers (QoS Management systems) with regards to Radio Access Technology (RAT) and the specified quality driven actions such as Radio Resource Management (RRM) strategies. The output of module 60 is the prediction frame 70, which is described earlier in this document (see description of FIG. 4). This frame is identical to that of 40, except for the information contained in octet6.

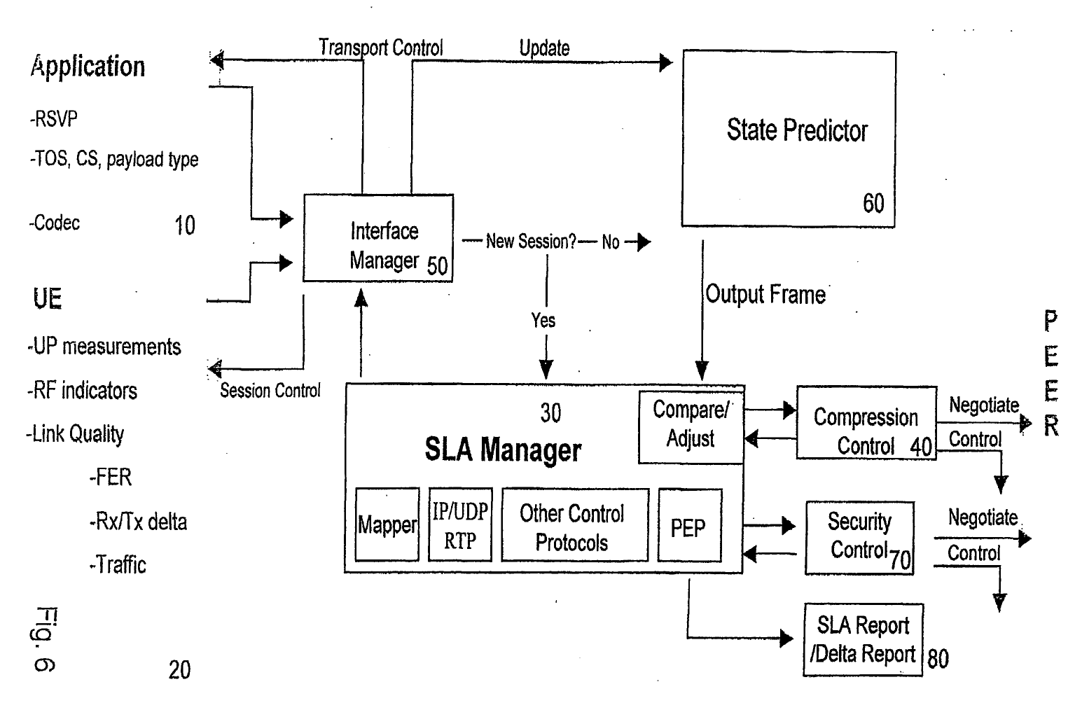

Referring to FIG. 6, a conceivable QoS management model designed as an UE stand alone client incorporating an exemplary embodiment of the current invention denoted here as the “State Predictor”. The following description is concerned with the interaction and practical use of the current invention in such a model. The UE measurements 20 are collected and forwarded via an interface manager 50. After establishing the session, the measurements are forwarded to the state predictor 60. Estimates concerning the future state of the current link expressed through variance estimates of the original input data are presented to the service level manager using the output frame format described in FIG. 4. The output frame also contains control level estimates such as Tx power gain. The latter is used by the SLA Manager to calculate the best point in time for each given action. Certain estimates contained in the output frame are forwarded to higher layer applications for further processing. The Service Level Manager will use the state predictions to set appropriate transport and compression protocol variables ahead of time 40 and 70. All these steps run on the mobile device.

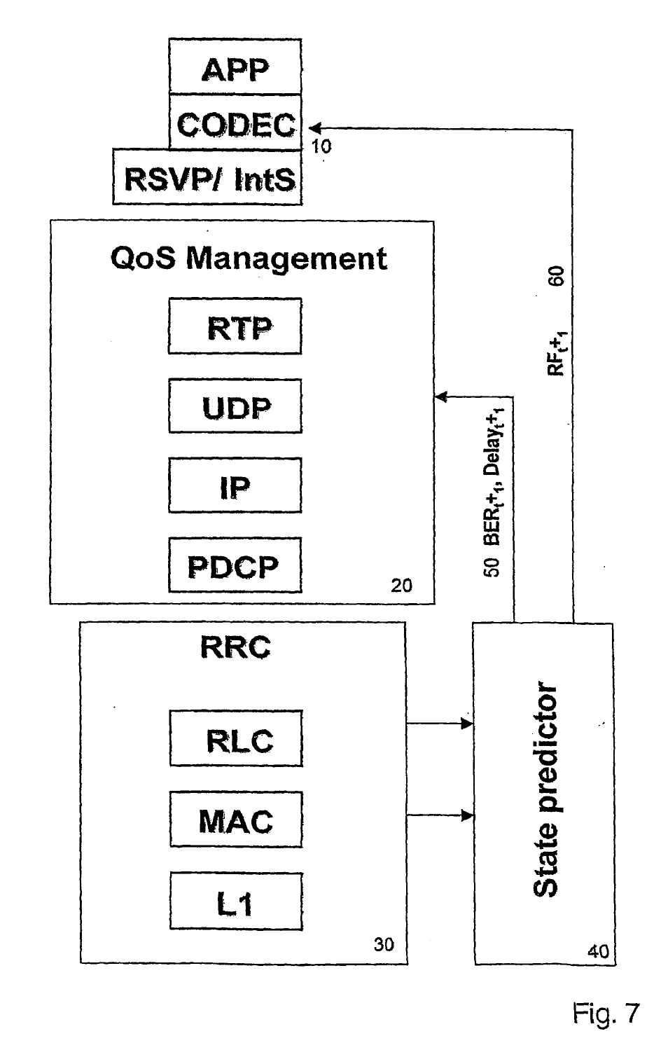

Referring to FIG. 7, the position of the current invention within a layered protocol model. Measurements from the radio transmission layer 30 are provided through the interface control agent C-SAPI of the RRC UE agent or any other conforming upper layer application, e.g. QoS Management System. Link state predictions concerning packet transport quality 50 are provided to the packet transport layers, while in certain cases RF quality indications are forwarded via the QoS Management system to the codec 10 or the application level.

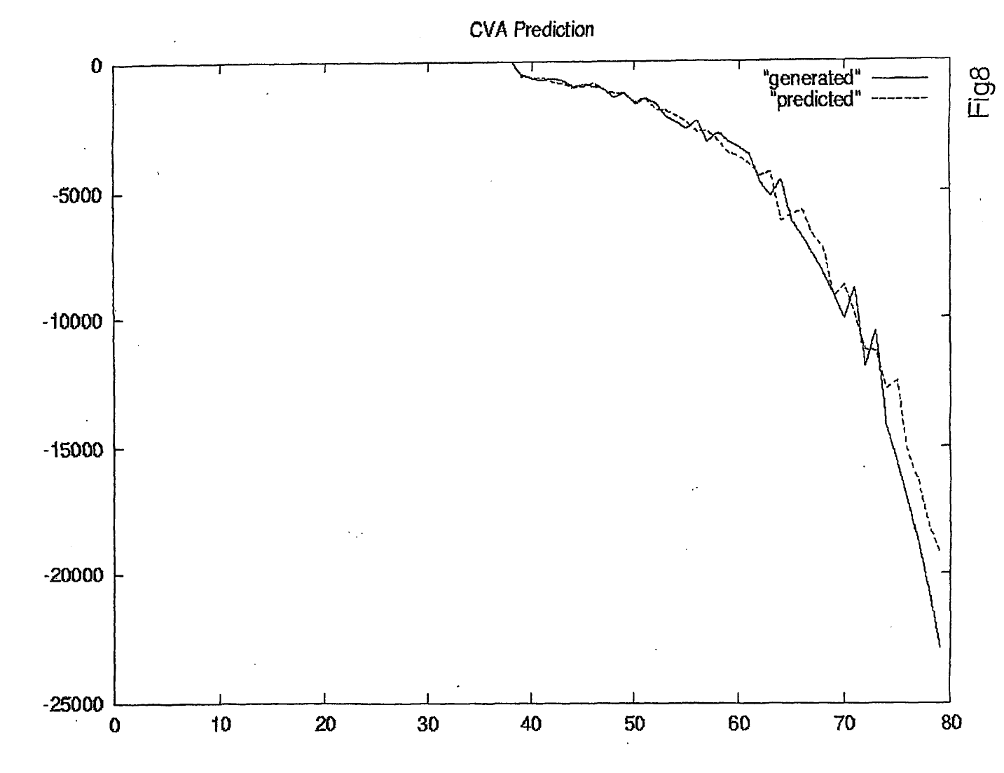

The graph in FIG. 8 shows a generated signal and its prediction starting at mark 40 at the X axis. Here the mark 40 is the point where the future starts. The past is not shown (0 . . . 40)—the past is used only to project into the future. The covariance matrices are computed in an off-line generation of samples. Here all data are experimental and serve the purpose of a model prediction output.

### REFERENCE

[1] TS 25.331: “RRC Protocol Specification”

[2] TS 25.322: “Radio Link Control (RLC) Protocol Specification”

[3] TS 25.321: “Medium Access Control (MAC) Protocol Specification”

[4] TS 25.215: “Physical layer—Measurements (FDD)”

[5] TS 25.225: “Physical layer—Measurements (TDD)”

[6] TS 25.932: “Access Stratum Delay Budget”

[7] TS 25.305: “Stage 2 Functional Specification of UE Positioning in UTRAN”

[8] TS 23.032: “Universal Geographical Area Description (GAD)”

[9] G. Golub, Ch. Van Loan: Matrix Computations, Johns Hopkins University Press, third edition, 1966

[10] Robust Header Compression (ROHC): Framework and four profiles: RTP, UDP, ESP, and uncompressed <draft-ietf-rohc-rtp-09.txt>

[11] EP 1 059 792 A2: “Method and system for wireless QoS agent for All-IP network”, Nortel Networks, 13.12.2000

[12] Larimore, W. E: (2000), “Identification of Colinear and Cointegrated Multivariable Systems Using Canonical Variate Analysis,” in Preprints of Symposium on System identification 2000, held Jun. 21-23, 2000, Santa Barbara, Calif.

[13] Golub, gene H. and Charles Van Loan, Matrix Computations, Third Edition, Johns Hopkins University Press, Baltimore, 1996

[14] TS 23.107: “QoS Concept and Architecture”

[15] Wallace E. Larimore, Franklin T. Luk, “System Identification and control using SVD's on Systolic Arrays”, SPIE Vol. 880 High Speed Computing (1988) QA 76.54#54, 1988

[16] draft-ietf-avt-ulp-00.txt: “An RTP Payload Format for Generic FEC with Uneven Level Protection”

[17] draft-ietf-avt-rtp-amr-06.txt: “RTP payload format and file storage format for AMR and AMR-WB audio”

[18] JP 09219697; U.S. Pat. No. 5,491,837; U.S. Pat. No. 5,710,791; U.S. Pat. No. 5,506,869; U.S. Pat. No. 5,845,208; U.S. Pat. No. 5,878,342; U.S. Pat. No. 5,886,988; U.S. Pat. No. 5,828,658; U.S. Pat. No. 6,101,383; U.S. Pat. No. 6,137,993; U.S. Pat. No. 5,794,155; WO 9610301; WO 9913660; WO 9951052; WO 0004739; WO 0025530; WO 0056103; WO 0033479; WO 9411972; EP 0455614;

[19] “Genetic Algorithms for Control and Signal Processing”, K. F. Man, S. Kwong, W. A. Halang, K. S. Tang, ISBN: 3540761012, Springer-Verlag New York, 1996

[20] “Genetic Algorithms in Optimization, Simulation & Modeling”, J. Stender, E. Hillebrand, J. Kingdon, ISBN: 9051991800, Press, Incorporated, 1994

[21] “Genetic Algorithms & Simulated Annealing”, Lawrence Davis, ISBN: 0273087711, Pitman Publishing, 1987

[22] “Applied Simulated Annealing”, Rene V. Vidal, ISBN: 038756229X, Springer-Verlag, 1993

[23] “Simulated Annealing: Theory and Applications”, P. J. Van Laarhoven, Emile H. Aarts, ISBN: 9027725136, Kluwer Academic Publishers, 1987

1. A mobile user device for a communication network, having means to run a process for predicting and/or improving the transport quality of packetized application data in a radio access environment comprising of the following steps:
a. recording quality measurements and control values periodically, in particular the received signal code power (RSCP) and/or position of said device and/or direction of said device and/or altitude of said device and/or velocity of said device and/or received signal strength indicator (RSSI) and/or block size and/or a codec and/or a header compression method and/or SNR and/or events
and/or
traffic volume and/or transmission delay and/or and/or block error rate and/or bit error rate and/or signal to interference ratio (SIR);
b. estimating future quality measurements periodically, in particular the traffic volume and/or transmission delay and/or block error rate and/or bit error rate and/or signal to interference ratio (SIR) by using a multidimensional stochastic algorithm, in particular based on covariance matrices and/or by using a neuron system Genetic and/or by using genetic algorithms and/or simulated annealing;
c.
c.1.1 calculating future control values if the future quality measurements don't match a predefined quality of service and adapting the control values if necessary and possible;
and/or
c.2.1 sending the estimating future quality measurements and/or the calculated future control values to a device in the network that is responsible for the adaptation of the control values in particular a base station and/or a radio network controller (RNC).

2. The device according to the previous claim, wherein said process compares said estimated quality measurements with the real quality measurements to adapt the algorithm in particular the covariance matrices and/or the neuron network, if the prediction error is above a defined level.

3. The device according to the previous claim, wherein the measurements are compared on a predefined metric.

4. The device according to claim 1, wherein a past vector pₜ consists of past outputs yₜ and past control inputs uₜ pₜ^{T}=(yₜ₋₁, yₜ₋₂, . . . , uₜ₋₁, uₜ₋₂, . . . ) wherein a future output is denoted by fₜ^{T}=(yₜ, yₜ₊₁, . . . ) and \hat{f}ₜ=Kpt wherein K consists of corresponding covariance matrices ΣₚₚΣ_{pf}, and Σ_{ff}.

5. The device according to the previous claim, wherein the solution for a minimized error
$$E \{ {‖ {f}_{t} - {\hat{f}}_{t} ‖}_{Λ}^{2} \} \to min$$
is given by K=Σ_{fp}JₖJₖ^{T}, where k is determined by Akaike Information Criterion (AIC), Jₖ represents the first k columns of J, and matrix is calculated from the Generalized Singular Value Decomposition (GSVD), namely to satisfy J^{T}ΣₚₚJ=Iₘ, L^{T}Σ_{ff}L=Iₙ, J^{T}Σ_{pf}L=D and D is a diagonal rectangular matrix consisting of generalized singular values.

6. Method for a mobile user device in a communication network, in particular a mobile PDA and/or a mobile cellular phone implementing a process for predicting and/or improving the transport quality of packetized application data in a radio access environment consisting of the following steps:
a. recording quality measurements and control values periodically, in particular a received signal code power (RSCP) and/or a position of said device and/or a direction of said device and/or an altitude of said device and/or a velocity of said device and/or a received signal strength indicator (RSSI) and/or a block size and/or a codec and/or a header compression method and/or SNR and/or events
and/or
traffic volume and/or transmission delay and/or and/or block error rate and/or bit error rate and/or signal to interference ratio (SIR);
b. estimating future quality measurements periodically, in particular the traffic volume and/or transmission delay and/or block error rate and/or bit error rate and/or signal to interference ratio (SIR) by using a multidimensional stochastic algorithm, in particular based on covariance matrices and/or by using a neuron system and/or genetic algorithms and/or simulated annealing;
c.
c.1.1 calculating future control values if the future quality measurements don't match a predefined quality of service and adapting the control values if necessary and possible;
and/or
c.2.1 sending the estimating future quality measurements and/or the calculated future control values to a device in the network that is responsible for the adaptation of the control values in particular a base station and/or a radio network controller (RNC).

7. Computer readable medium storing a loadable data structure implementing the process according to the previous claim on a mobile phone and/or PDA after being loaded.

8. A network for a mobile user device including network controlling components in particular a base stations and/or a radio network controller,
wherein said network components allow the mobile user device to access and record quality measurements and control values periodically, in particular a received signal code power (RSCP) and/or position of said device and/or a direction of said device and/or an altitude of said device and/or a velocity of said device and/or a received signal strength indicator (RSSI) and/or a block size a codec and/or a header compression method,
wherein said network components allow the mobile user device to estimating future quality measurements periodically, in particular the traffic volume and/or transmission delay and/or block error rate and/or bit error rate and/or signal to interference ratio (SIR) by using a multidimensional stochastic algorithm, in particular based on covariance matrices and/or by using a neuron system,
wherein said network components allow the mobile user device to calculating future control values
and if the future quality measurements don't match a predefined quality of service said network component allow the mobile user device to modify said control values,
and/or
wherein said network components having means to receive the estimated future quality measurements and/or the calculated future control values of said mobile user device in order to adapt the control values in the future if the future quality measurements don't match a predefined quality of service.
